(19) United States
(12) Patent Application Publication
(10) Pub. No.: US 2023/0340174 A1
(43) Pub. Date: Oct. 26, 2023

(54) Sustainable Graft Polymers and Methods for Making and Recycling

(71) Applicants: Junpeng Wang, Peninsula, OH (US); Zeyu Wang, Akron, OH (US); Seiyoung Yoon, Stow, OH (US)

(72) Inventors: Junpeng Wang, Peninsula, OH (US); Zeyu Wang, Akron, OH (US); Seiyoung Yoon, Stow, OH (US)

(21) Appl. No.: 18/154,957

(22) Filed: Jan. 16, 2023

Related U.S. Application Data
(60) Provisional application No. 63/320,370, filed on Mar. 16, 2022.

(51) Int. Cl. C08F 257/02

(52) U.S. Cl. CPC C08F 257/02

(57) ABSTRACT

A macromonomer capable of forming a graft polymer through graft-through polymerization, the macromonomer including a plurality of monomer units including a cycloalkene having a fused ring attached thereto to form a cycloalkene-fused ring monomer where the fused ring decreases the ring strain energy of the cycloalkene to a lower ring strain energy state of 5.3 kcal/mol or lower and where the cycloalkene of the cycloalkene-fused ring monomer is capable of isomerization into a higher ring strain energy state before graft-through polymerization, and at least one polymer sidechain is bonded to the fused ring. Graft polymers formed by the macromonomer include graft polymers and graft copolymers including statistical and block copolymers. The graft (co)polymers are capable of depolymerization under mild conditions into reusable monomer units.

### CROSS REFERENCE TO RELATED APPLICATIONS

This application claims the benefit of U.S. Provisional Pat. Application Serial Number US 63/320,370 filed Mar. 16, 2021, which is incorporated herein by reference in its entirety.

### STATEMENT REGARDING FEDERALLY SPONSORED RESEARCH OR DEVELOPMENT

This invention was made with government support under DMR 2042494 awarded by National Science Foundation. The government has certain rights in the invention.

### FIELD OF THE INVENTION

In particular embodiments, the invention relates to modification of cycloalkenes that polymerize through ring-opening metathesis polymerization, the modification providing a fused ring that decreases the ring strain energy (RSE) to an amount suitable for convenient depolymerization. In some embodiments, the cycloalkenes are further modified through cis-to-trans alkene isomerization of the cycloalkene to increase ring strain energy to promote living ring-opening metathesis polymerization, even at reduced monomer concentrations. In some embodiments, the fused ring includes functionalization that can be efficiently depolymerized under mild conditions for chemical recycling to monomers (CRM). In some embodiments,

### BACKGROUND OF THE INVENTION

Synthetic polymers, including synthetic rubber and synthetic plastics, have been used in nearly every aspect of our daily lives. The dominance of synthetic polymers is largely driven by their excellent stability and processability as well as their versatile mechanical properties. However, due to their high durability, waste materials composed of these polymers have accumulated in the ocean and have caused serious concerns for marine ecosystems. In addition, because 90% of these polymers are derived from finite fossil feedstocks, the production of these materials is unsustainable if they cannot be recycled and reused. Efforts to address these issues include the development of biodegradable polymers and mechanical recycling. However, most biodegradable polymers that can be degraded in artificial environments do not undergo efficient degradation in seawater, giving rise to new environmental consequences. Mechanical recycling of polymers typically results in substantial loss of quality, and the recycled material is not suitable for high-performance applications.

Graft polymers are a class of macromolecules with grafted sidechains, affording unique properties that are useful for numerous technologies, such as touch sensors, tissue-mimicking elastomers, and photonic crystals.

Thus, there is a need for chemically recyclable polymers that can depolymerize into their constituent monomers for recycling and repolymerization. Circular use of the materials not only will help to preserve finite natural resources but also can address end-of-life issues for such materials.

Specifically, there is a need for recyclable graft polymers. Graft polymers, owing to their grafted structures, possess unique properties useful for a broad range of applications. Depolymerizable graft polymers are rare, and existing examples of depolymerizable graft polymers lack the rigor in controlling the size and architecture.

To replace currently available commercial polymers, depolymerizable polymers need to match or exceed the properties of the current ones. With exceptions, polymerization is typically favored in enthalpy (ΔH < 0) and disfavored in entropy (ΔS < 0). The temperature at which the entropic loss will offset the enthalpic gain is defined as the ceiling temperature T_{c}, and depolymerization is favored when the temperature is above T_{c}. Common polymers such as polyolefins have high T_{c} values, and their depolymerization is either costly in terms of energy or is susceptible to decomposition. Classical low-T_{c} polymers such as poly(olefin sulfones), poly(α-methyl styrene), and polyaldehydes lack high thermal and chemical stability, and their use has been limited to certain specific applications such as transient electronics.

A promising strategy to address the stability issues is to develop polymers that only undergo efficient depolymerization in the presence of a catalyst. In other words, without the catalyst, the polymer is in a kinetic trap so that it will stay intact even when the temperature is above T_{c}. Recently, it has been shown that ring-opening polymerization of certain cyclic monomers―such as cyclic esters, cyclic carbonates, and cyclic olefins-can lead to polymers that can depolymerize into the corresponding monomers in the presence of catalysts but show high thermal stability when the catalysts are removed. For example, Chen and coworkers, Zhu, J.-B., Watson, E. M., Tang, J. & Chen, E. Y. X. A synthetic polymer system with repeatable chemical recyclability, Science360, 398-403 (2018), have shown that a poly(γ-butyrolactone) required heating overnight at 300° C. to be depolymerized, but the depolymerization temperature was reduced to 120° C. when a ZnCl₂ catalyst was added.

Among catalytically depolymerizable polymers, ones that are formed through olefin metathesis are particularly attractive since olefin metathesis does not occur without a catalyst, and unintended depolymerization can thus be prevented by removing the catalyst. In addition, metathesis is compatible with a wide variety of functional groups and can be conducted in mild or ambient reaction conditions. Metathesis-based depolymerizable polymers are typically made via ring-opening metathesis polymerization (ROMP) of cycloalkenes and can depolymerize through ring-closing metathesis (RCM) to form the corresponding monomers. Compared to the ring-opening polymerization that is based on cyclic esters and cyclic carbonates, ROMP enables the production of polymers with hydrocarbon backbones, which have greater hydrolytic and thermal stability.

Depolymerizable ROMP polymers have been largely limited to those of the five-membered cyclic olefins, such as cyclopentene and 2,3-dihydrofuran.

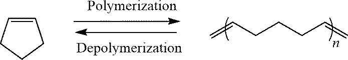

However, living ROMP of the five-membered cyclic olefins is challenging due to their low ring strain. On the other hand, the living ROMP of high-strain monomers, such as norbornene, 7-oxanorbomene, cyclopropene, cyclobutene and trans-cyclooctene have been demonstrated, but they do not depolymerize.

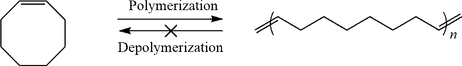

For an efficient living ROMP, the high strain is essential as it favors the propagation over secondary metathesis that causes undesirable chain transfer. It is therefore challenging, if not impossible, to realize both living ROMP and depolymerization of the resulting polymer, as the polymer is not readily broken down to its high-strain monomers.

Thus, there exists a need for chemically recyclable monomers that can undergo depolymerization under mild conditions.

### SUMMARY OF THE INVENTION

An embodiment of the present invention provides a macromonomer capable of forming a graft polymer through graft-through polymerization, the graft polymer being capable of depolymerization, the macromonomer comprising a plurality of monomer units, the monomer units comprising a cycloalkene having a fused ring attached thereto to form a cycloalkene-fused ring monomer, wherein the fused ring decreases the ring strain energy of the cycloalkene to a lower ring strain energy state of 5.3 kcal/mol or lower as compared to the same cycloalkene without the fused ring having a ring strain energy above 5.3 kcal/mol, and wherein the cycloalkene of the cycloalkene-fused ring monomer is capable of isomerization into a higher ring strain energy state before graft-through polymerization, and at least one polymer sidechain bonded to the fused ring.

Another embodiment of the present invention provides a macromonomer capable of forming a graft polymer through graft-through polymerization, the graft polymer being capable of depolymerization as in any embodiment above, wherein the at least one polymer sidechain bonded to the fused ring comprises one or more of a poly(ethylene glycol), a polylactide, an aliphatic chain, a polycaprolactone, a polystyrene, and a polyacrylate.

Another embodiment of the present invention provides a macromonomer capable of forming a graft polymer through graft-through polymerization, the graft polymer being capable of depolymerization as in any embodiment above, wherein the cycloalkene is a 7- to 12-membered cycloalkene.

Another embodiment of the present invention provides a macromonomer capable of forming a graft polymer through graft-through polymerization, the graft polymer being capable of depolymerization as in any embodiment above, wherein the cycloalkene is an 8-membered cycloalkene, cyclooctene.

Another embodiment of the present invention provides a macromonomer capable of forming a graft polymer through graft-through polymerization, the graft polymer being capable of depolymerization as in any embodiment above, wherein the fused ring comprises trans-cyclobutane or trans-cyclopentane.

Another embodiment of the present invention provides a macromonomer capable of forming a graft polymer through graft-through polymerization, the graft polymer being capable of depolymerization as in any embodiment above, wherein the at least one polymer sidechain bonded to the fused ring is bonded after formation of the cycloalkene-fused ring monomer.

An embodiment of the present invention provides a graft polymer comprising a macromonomer backbone comprising a plurality of monomer units, a plurality of polymer sidechains, where each polymer sidechain is bonded to one of the monomer units, wherein each monomer unit of the plurality of monomer unites comprises a cycloalkene having a fused ring attached thereto to form a cycloalkene-fused ring monomer, wherein the fused ring decreases the ring strain energy of the cycloalkene to a lower ring strain energy state of 5.3 kcal/mol or lower as compared to the same cycloalkene without the fused ring having a ring strain energy above 5.3 kcal/mol, and wherein the cycloalkene of the cycloalkene-fused ring monomer is capable of isomerization into a higher ring strain energy state before graft-through polymerization, wherein the macromonomer backbone is synthesized by ring-opening metathesis polymerization of the plurality of monomer units.

Another embodiment of the present invention provides a graft polymer as in any embodiment above, wherein the graft polymer is a bottlebrush polymer.

Another embodiment of the present invention provides a graft polymer as in any embodiment above, wherein a degree of polymerization is 1 or greater to 3,000.

Another embodiment of the present invention provides a graft polymer as in any embodiment above, wherein a degree of polymerization is ultrahigh.

Another embodiment of the present invention provides a graft polymer as in any embodiment above, wherein a degree of polymerization is 3,000.

Another embodiment of the present invention provides a graft polymer as in any embodiment above, wherein a number average molecular weight is 5,000 kDa or greater.

Another embodiment of the present invention provides a graft polymer as in any embodiment above, wherein upon a depolymerization returns to a lower ring strain energy for each monomer unit.

Another embodiment of the present invention provides a graft polymer as in any embodiment above, wherein the plurality of polymer sidechains comprises one or more of a poly(ethylene glycol), a polylactide, an aliphatic chain, a polycaprolactone, a polystyrene, and a polyacrylate.

An embodiment of the present invention provides a graft copolymer comprising a first graft polymer comprising a first macromonomer backbone comprising a plurality of first monomer units and a plurality of first polymer sidechains, wherein each polymer sidechain of the plurality of first polymer sidechains is bonded to each one of the plurality of first monomer units, a second polymer covalently linked to the first polymer.

Another embodiment of the present invention provides a graft copolymer as in any embodiment above, wherein the second polymer comprises a second macromonomer backbone comprising a plurality of second monomer units and a plurality of second polymer sidechains, wherein each polymer sidechain of the plurality of second polymer sidechains is bonded to each one of the plurality of second monomer units.

Another embodiment of the present invention provides a graft copolymer as in any embodiment above, wherein the graft polymer is a statistical copolymer.

Another embodiment of the present invention provides a graft copolymer as in any embodiment above, wherein the graft polymer is a block copolymer.

An embodiment of the present invention provides a method of synthesizing a graft polymer, the method comprising providing a plurality of monomer units, the monomer units comprising a cycloalkene having a fused ring attached thereto to form a cycloalkene-fused ring monomer, wherein the fused ring decreases the ring strain energy of the cycloalkene to a lower ring strain energy state of 5.3 kcal/mol or lower as compared to the same cycloalkene without the fused ring having a ring strain energy above 5.3 kcal/mol, and wherein the cycloalkene of the cycloalkene-fused ring monomer is capable of isomerization into a higher ring strain energy state, and wherein a polymer sidechain is bonded to each fused ring of the monomer units, isomerizing the plurality of monomer units into the higher ring strain energy state, performing ring-opening metathesis polymerization on the plurality of monomer units to obtain the graft polymer.

Another embodiment of the present invention provides a method of synthesizing a graft polymer as in any embodiment above, further comprising depolymerizing the graft polymer to obtain a plurality of monomer units wherein the cycloalkene of each monomer unit is in a lower ring strain energy state.

### BRIEF DESCRIPTION OF THE DRAWINGS

FIG. 1 provides a general schematic representation of the lowering of ring strain energy (RSE) of a cycloalkene to permit polymerization and depolymerization..

FIG. 2 provides a table showing structures and calculated RSEs for cyclooctene with 3-, 4-, 5- and 6-membered rings both cis- and trans-fused at the 5 and 6 positions.

FIG. 3 shows a general scheme of polymerization and depolymerization techniques for graft polymers according to the present invention.

FIG. 4 shows a SAXS profile of a graft block copolymer according to the present invention indicating a lamellar morphology.

FIG. 5 shows the retention time of a graft polymer according to the present invention during a depolymerization procedure..

FIG. 6 shows the fractions of remaining polymer, oligomers, macromonomer, and oligomers/macromonomer as a function of depolymerization versus time.

FIG. 7 shows the normalized molecular weight and dispersity of a polymer according to the present invention as a function of depolymerization percentage relative to two hypothetical curves.

FIG. 8 shows a representative stress-strain curve of a dumbbell specimen of a graft statistical copolymer according to the present invention, as well as unstretched and stretched dumbbell specimens.

### DETAILED DESCRIPTION OF ILLUSTRATIVE EMBODIMENTS

The following is a detailed description of the disclosure provided to aid those skilled in the art in practicing the present disclosure. Those of ordinary skill in the art may make modifications and variations in the embodiments described herein without departing from the spirit or scope of the present disclosure. Unless otherwise defined, all technical and scientific terms used herein have the same meaning as commonly understood by one of ordinary skill in the art to which this disclosure belongs. The terminology used in the description of the disclosure herein is for describing particular embodiments only and is not intended to be limiting of the disclosure.

The present invention relates to novel graft polymers capable of undergoing depolymerization to monomers comprising a macromonomer backbone having polymeric sidechains grafted thereon. Most preferably, the macromonomer backbone comprises a plurality of monomer units each comprising a cycloalkene having a fused ring attached thereto to form a cycloalkene-fused ring monomer. Further, the polymeric side chains are each attached to the fused ring of each of the plurality of monomer units. The graft polymers according to the present invention further include statistical copolymers as well as block copolymers. The present invention further relates to a process for obtaining such a graft polymer, the process is preferably carried out by living ROMP of the plurality of monomer units.

In one or more embodiments, graft polymers according to the present invention include bottlebrush polymers.

In one or more embodiments, graft polymers according to the present invention have an ultrahigh molecular weight while maintaining 90% or greater conversion and low dispersity, Ð < 1.2. An ultrahigh molecular weight is understood to be a molecular weight of 14,000 kDa or greater. In some embodiments, graft polymers according to the present invention have a molecular weight of 5,000 kDa or greater. In other embodiments, 6,000 kDa or greater. In other embodiments, 7,000 kDa or greater. In other embodiments, 8,000 kDa or greater. In other embodiments, 9,000 kDa or greater. In other embodiments, 10,000 kDa or greater. In other embodiments, 11,000 kDa or greater. In other embodiments, 12,000 kDa or greater. In other embodiments, 13,000 kDa or greater. In other embodiments, 14,000 kDa or greater. In other embodiments, 15,000 kDa or greater.

Many properties including thermal, mechanical, surface energy and wetting behavior, solubility, chemical resistance, and other properties such as such as transparency, dielectric constant, conductivity, and optical properties are tunable according to backbone length and the selection of polymer sidechains.

In one or more embodiments, graft polymers according to the present invention are depolymerizable. For the purposes of this disclosure it is understood that depolymerizable means that when exposed to mild conditions, graft polymers of the present invention, depolymerize into macromonomers, which may be used to create a new polymer.

The plurality of monomer units is not particularly limited and one of ordinary skill in the art will be able to select a suitable plurality of monomer units without undue experimentation. In various embodiments, a suitable plurality of monomer units may include, without limitation, cycloalkene fused ring monomers.

Suitable monomer units for the plurality of monomer units according to the present invention are formed through the attachment of a fused ring to a cycloalkene. The addition of the fused ring allows the polymer to be depolymerizable by reducing the RSE in the cycloalkene monomers from a value greater than 5.3 kcal mol-¹ (without fused ring) to a value equal to or lower than 5.3 kcal mol-¹(with fused ring). In some embodiments involving cycloalkenes of 8 carbons or more, the cycloalkene is isomerized to convert the cycloalkene to a trans-configuration (also known as the corresponding E-cycloalkene). In some embodiments, the fused ring includes a polymeric sidechain. The polymeric sidechain may also be referred to as a polymer sidechain and refers to the polymeric sidechain of the graft polymer attached to the macromonomer backbone.

In some embodiments, the cycloalkenes that are modified with the fused rings including from 7- to 12- membered rings. In some embodiments the cycloalkene is based on cycloheptene (7-membered ring). In some embodiments the cycloalkene is based on cyclooctene (8-membered ring). In some embodiments the cyclic olefin is based on cyclononene (9-membered ring). In some embodiments the cyclic olefin based on cylcodecene (10-membered ring). In some embodiments the cyclic olefin is based on cycloundecene (11-membered ring). In some embodiments the cyclic olefin is based on cycloduodecene (12-membered ring).

An 8-membered cyclic olefin is particularly advantageous because functionalized cyclooctenes can typically be made from 1,5-cyclooctadiene, an inexpensive, commercially available starting material. As a result, polycyclooctene is one of the most extensively exploited polycycloalkenes.

In some embodiments the fused ring is a cycloalkane. Suitable fused rings for the present invention include 3- member to 6-membered fused rings. In some embodiments the fused ring is cyclopentane. In some embodiments the fused ring is cyclopentane. In some embodiments the fused ring is cyclopentane. In some embodiments the fused ring is cyclopentane. In some embodiments the fused ring is cyclohexane.

In some embodiments the fused ring is cis-fused or trans-fused. In some embodiments the fused ring is cis-fused. In some embodiments the fused ring is trans-fused.

In some embodiments, the fused ring is at least 2 carbon atoms removed from the double bond. In other embodiments, the fused ring is opposite the double bond or as closely opposite as possible for odd-membered rings. In some embodiments with a 7-membered cycloalkene, the fused ring is at the 3 and 4 position or the 4 and 5 position. In some embodiments with an 8-membered cycloalkene, the fused ring is at the 5 and 6 position. In some embodiments with a 9-membered cycloalkene, the fused ring is at the 5 and 6 position or the 6 and 7 position. In some embodiments with a 10-membered cycloalkene, the fused ring is at the 6 and 7 position. In some embodiments with an 11-membered cycloalkene, the fused ring is at the 6 and 7 position or the 7 and 8 position. In some embodiments with a 12-membered cycloalkene, the fused ring is at the 7 and 8 position.

Suitable cycloalkenes for the present invention can be identified by the generalized ring-closing metathesis reaction used to calculate the RSE of a cyclic olefin; the RSE for the cyclic olefin is essentially the enthalpy change for the ring-closing metathesis that affords the cyclic olefin, as shown in the exemplary scheme below.

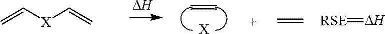

In accordance with this invention, the addition of the fused ring serves to reduce the RSE in the cycloalkene monomers from a value greater than 5.3 kcal mol⁻¹, without the fused ring, to a value equal to or lower than 5.3 kcal mol⁻¹, with the fused ring. To identify a fused ring that can lower the ring strain of cyclooctene to the above-mentioned target, the RSEs of cyclooctenes with three-, four-, five- and six-membered rings fused at the 5 and 6 positions, including both cis and trans isomers, were calculated. The computation of RSE was conducted by calculating the enthalpy change of the RCM reaction using density functional theory at the B3LYP/6-31G(d,p) level, which provided reasonable predictions for the RSEs of cyclic olefins.

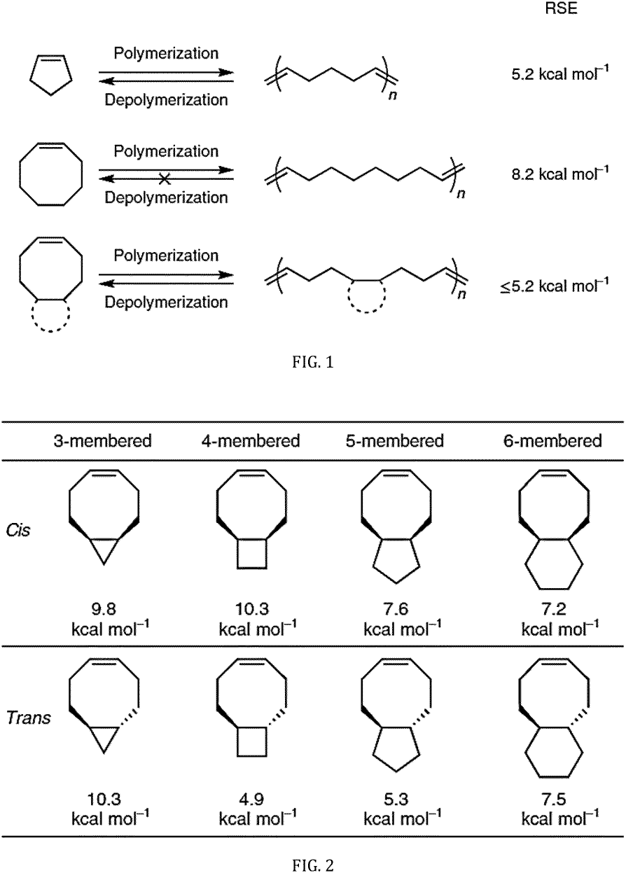

As shown in FIG. 1, polycyclopentene is depolymerizable, whereas polycyclooctene is not. The difference can be attributed to the higher RSE in cyclooctene. An appropriate ring (shown as a dashed line in FIG. 1) is provided in accordance with this invention to lower the RSE of cyclooctene to a level that is lower than or comparable to that of cyclopentene, enabling depolymerization of the polymer.

By way of example, the calculated RSEs for cyclooctene with 3-, 4-, 5- and 6-membered rings both cis- and trans-fused at the 5 and 6 positions are shown in FIG. 2.

Based on the difference in RSE between the fused rings and the unsubstituted cyclooctene (RSE = 8.2 kcal mol⁻¹), the calculated results can be sorted into three groups:
1. RSEs that are higher than that of the virgin cyclooctene, including cis-cyclopropane-, trans-cyclopropane- and cis-cyclobutane-fused cyclooctenes
2. Fused rings with slightly decreased ring strain, including cis-cyclopentane-, cis-cyclohexane- and trans-cyclohexanefused cyclooctenes
3. Cycloalkane-fused cyclooctenes having the lowest RSEs and having RSEs that are lower than or comparable to that of cyclopentene (RSE = 5.2 kcal mol⁻¹), including trans-cyclobutane and trans-cyclopentane-fused cyclooctenes

The calculated RSEs of the ROMP polymers of the trans-cyclobutane-fused cyclooctenes and trans-cyclopentane-fused cyclooctenes indicate that the obtained polymers from these monomers are suitable for catalytic depolymerization in a way similar to polypentenamers.

Polymerization is limited at near-equilibrium (monomer/polymer concentration) conditions in low ring strain cycloalkene systems. This limits full conversion polymerization. Further, the reduced driving force during polymerization inhibits synthesizing block copolymers as including a second monomer dilutes the first monomer, causing depolymerization of the first block.

A polymerization system based on near-equilibrium polymerization and/or depolymerization is characterized by low driving force in polymerization. Isomerizing the monomer into a high-energy state, i.e. increasing the ring strain energy of the cycloalkene fused ring system, enables high driving force during polymerization, and the resulting polymer can advantageously depolymerize back into the low-energy state monomer, i.e. low ring strain energy configuration.

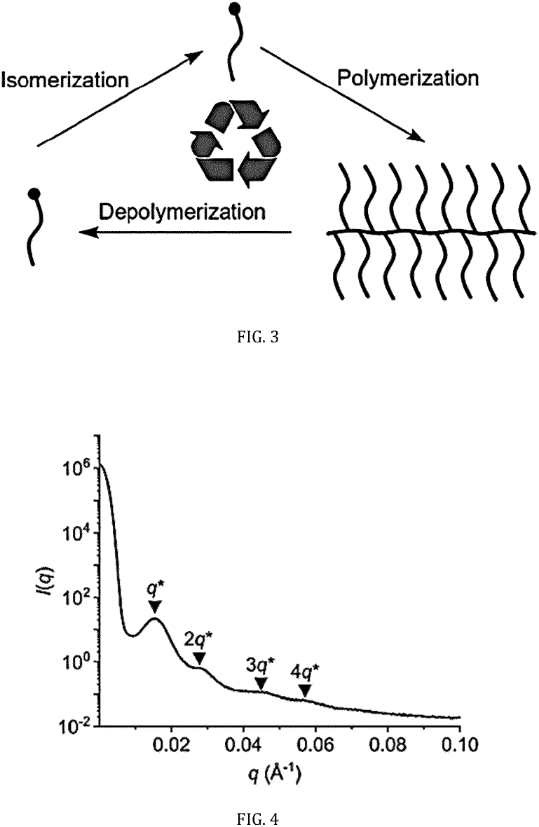

As shown in FIG. 3, a polymerization and depolymerization life cycle is shown. Specifically, isomerization of the macromonomer prior to polymerization increases the driving force of polymerization, enabling the formation of graft polymers. Further, the obtained graft polymers remain depolymerizable back into the lower energy state macromonomer.

In some embodiments, focusing particularly on those monomers in accordance with this invention having an 8-membered or higher cycloalkene, the ring strain of the monomer is increased by isomerization of the cycloalkene from a cis-alkene to a trans-alkene, which would also be appreciated at least in some embodiments as isomerization from a Z-alkene to an E-alkene at the cycloalkene.

Cyclooctene in its cis-cyclooctene conformation may also be called Z-cyclooctene, and is convertible to an E-cyclooctene, or a trans-cyclooctene conformation. This increases ring strain energy and promotes kinetic-driven ROMP in the presence of a ruthenium catalyst. As a result of this increased driving force during polymerization full polymerization conversation at lower initial monomer concentrations is possible. Further, the resulting corresponding polymer maintains chemical recyclability to monomers during mild depolymerization to advantageously form the low ring strain energy state monomer.

In one or more embodiments, isomerizing the monomers according to the present invention may be performed according to conventional and known methods in the art. Suitable methods isomerization techniques preserve the functionality that may be present on the fused ring included in monomers according to the present invention.

Isomerization techniques relating to olefin inversion include direct isomerization, including thermal-chemical isomerization and photoisomerization, oxidative additions to alkenes followed by reductive elimination, cleavage of epoxides followed by anti or syn elimination, fragmentation of thiiranes and related heterocycles, fragmentation of aziridines and related heterocycles, fragmentations of heterocycles based on vic-diols, dithiols, and interconversion of other alkene geometrical isomers.

In some embodiments, isomerization of the cycloalkene-fused ring monomer is performed using a three-step sequence involving epoxidation, formation of β-hydroxy diphenylphosphine oxide, and elimination. This isomerization method is not compatibile with ester and imide functional groups.

In some embodiments, isomerization of the cycloalkene-fused ring monomer is performed using photochemical isomerization in the presence of silver nitrate, which selectively binds to the trans-cycloalkene to form a water-soluble metal complex. Subsequent demetallation via washing with ammonium hydroxide provides the trans-cycloalkene-fused ring monomer. This method of isomerization is compatible with many functional groups that may be present on the fused ring including hydroxyl, esters, and imides. Further, the method involves a single-step reaction. Batch processing according to this method has low yields (less than 10%) due to photodegradation of the trans-cycloalkene-fused ring monomer. Performing this method using a continuous flow column improves yields due to reduced photodegradation (exposure to UV light) effects. Thus, it is advantageous to use continuous processing to avoid photodegradation of the trans-cycloalkene-fused ring monomer.

In some embodiments, the fused rings are functionalized. Functionality may be selected to alter thermomechanical properties of the resulting polymer. Examples of such thermomechanical properties include T_{d} and T_{g} which may be increased or decreased according to the functionality included on the fused ring. Generally, cyclic functional groups exhibit higher T_{g} than acyclic function groups. Additionally, longer alkyl chains provide polymers with a lower T_{g} than shorter alkyl chains.

An objective of the present invention is to provide olefin metathesis-based chemically recyclable semi-fluorinated polymers enabled by fused-ring monomers. These polymers exhibit high thermal stability, hydrophobicity, and tunable thermomechanical properties. In addition, the present invention provides for block copolymers that comprise a semi-fluorinated block and a block containing poly(ethylene glycol) (PEG) side chains. Further, the present invention provides for post-functionalization of a pentafluorophenyl imide functionalized polymer demonstrating the ability to further modify the system.

Chemically recyclable monomers according to the present invention may be synthesized according to the description above regarding [2+2] photocycloaddition and further including esterification or reaction with pentafluoroaniline to generate an imide. Further, the [2+2] photocycloaddition may be carried out using alternative reactants to produce functionalized fused rings trans-fused to a cycloalkene.

In some embodiments of the present invention, functionalization of the fused ring of monomers according to the present invention provides for semi-fluorinated polymers after performing living ROMP. Advantageously, semi-fluorinated polymers according to the present invention are chemically recyclable to monomers in the presence of a catalyst under ambient conditions.

In some embodiments, the fused ring is the site where polymeric sidechains are attached. Suitable polymeric sidechains include including poly(ethylene glycol), polylactide, aliphatic chains, polycaprolactone, polystyrene, and polyacrylate.

A further objective of the present invention is to provide methods of synthesizing graft polymers. Generally, it is understood that graft polymer architecture can be achieved using one of three methods: grafting-to, grafting-from, and grafting-through. Both grafting-to and grafting-from methods are based on a preformed polymer backbone, and the sidechain is formed either by attaching a polymer to the polymer backbone using a coupling reaction (grafting-to) or by growing polymer chains from initiators on the polymer backbone (grafting-from). Grafting-to is advantageous in that it allows for separate preparation and characterization of the backbone and the sidechain, due to steric hindrance, grafting becomes progressively more difficult as conversion increases, leading to limited grafting density. Compared to the grafting-to route, grafting-from typically renders improved control in grafting density, but the efficiency of the initiators on the polymer backbone could be affected by the high density of initiation sites. Additionally, it is not straightforward to pre-pare more complex architectures, such as graft block copolymers, from either grafting-to or grafting-from methods.

Previous attempts at developing depolymerizable graft polymers have fallen short. Specific attempts include ROMP of norbornene-derived macromonomers. The exergonic nature of the polymerization used for grafting-through makes the corresponding graft polymers non-depolymerizable. Existing depolymerizable graft polymers typically lack robustness in controlling their architecture, functionality, and size. For example, the depolymerizable polycyclopentene bottlebrushes based on the grafting-from approach require delicate temperature control during the synthesis of the backbone; in addition, monomer conversion needed to be limited at a low level (<10%) during the synthesis of the sidechain to obtain narrow molecular weight distribution. Depolymerizable graft polymers have also been prepared using controlled radical polymerizations of macromonomers, but these reactions have limited efficiencies and accessible molecular weights.

Advantageously, graft polymers according to the present invention are synthesized using the grafting-through approach. The grafting-through approach starts with a macromonomer (MM) that comprises a monomer and a polymer chain: polymerization of the monomer forms the backbone, and the polymer chain on the macromonomer becomes the sidechain of the corresponding graft copolymer. Compared to the other two methods, grafting-through is advantageous in its facile and precise control over the backbone length, sidechain types and length, grafting density, and polymer architecture, provided that the polymerization of the macromonomer is well controlled. The living ROMP of the plurality of monomers according to the present invention is robust enough to overcome the low concentration and steric effects caused by the long sidechains in MMs, affording controlled polymerization. Various polymer architectures of graft copolymers are achieved, including a block copolymer and a statistical copolymer, and from the latter was prepared a ductile thermoplastic material.

Examples of polymerization chemistry for grafting-through include polyaddition of olefins and ring-opening metathesis polymerization (ROMP) of norbornene derivatives. ROMP of norbornene-derived macromonomers is used for synthesizing graft polymers, because of the mild reaction conditions, excellent functional group tolerance, and ease of operation.

In some embodiments, a method of synthesizing a graft polymer according to the present invention includes providing a plurality of monomer units, isomerizing the plurality of monomer units into the higher ring strain energy state, and performing ring-opening metathesis polymerization on the plurality of monomer units to obtain the graft polymer.

In some embodiments, the step of providing a plurality of monomer units includes synthesizing any of the monomers described in the present invention.

In some embodiments, the step of isomerizing the plurality of monomer units into the higher ring strain energy state includes cis-to-trans isomerization. In other embodiments the step of isomerizing the plurality of monomer units into the higher ring strain energy state includes trans-to-cis isomerization. Isomerization of the plurality of monomer units advantageously provides for the driving force of polymerization to be temporarily elevated so that controlled polymerization can be achieved at monomer concentrations as low as 25 mM.

In some embodiments, the step of performing ring-opening metathesis polymerization on the plurality of monomer units to obtain the graft polymer includes synthesizing one or more of a graft polymer or graft copolymers. Graft copolymers include block copolymers and statistical copolymers.

In some embodiments, the cycloalkene-fused ring monomer is polymerized using living ROMP including using a catalyst as an initiator, a weakly coordinating ligand, a coordinating solvent.

In some embodiments, suitable catalysts for living ROMP include ruthenium catalysts. In these and other embodiments ruthenium catalysts include first-generation, second-generation, third-generation Grubbs catalysts, as well as first-generation and second-generation Hoveyda-Grubbs catalysts. Polymers formed from the cycloalkene-fused ring monomer are capable of undergoing depolymerization in the presence of a ruthenium catalyst. Living ROMP will proceed without depolymerization when certain conditions are met using a ruthenium catalyst.

In embodiments of the present invention using ruthenium catalysts for living ROMP of the isomerized cycloalkene-fused ring monomer, living ROMP is considered to proceed without depolymerization when the polymerization percentage is 90% or greater. In other embodiments, when the polymerization is 91% or greater. In other embodiments, when the polymerization is 92% or greater. In other embodiments, when the polymerization is 93% or greater. In other embodiments, when the polymerization is 94% or greater. In other embodiments, when the polymerization is 95% or greater. In other embodiments, when the polymerization is 96% or greater. In other embodiments, when the polymerization is 97% or greater. In other embodiments, when the polymerization is 98% or greater. In other embodiments, when the polymerization is 99% or greater.

In embodiments of the present invention using ruthenium catalysts for living ROMP of the isomerized cycloalkene-fused ring monomer, living ROMP is considered to proceed without depolymerization when the depolymerization percentage is 5% or lower. In other embodiments, when the depolymerization percentage is 4% or lower. In other embodiments, when the depolymerization percentage is 3% or lower. In other embodiments, when the depolymerization percentage is 2% or lower. In other embodiments, when the depolymerization percentage is 1% or lower.

The initial concentration of monomer directly relates to the overall conversion to polymer during living ROMP. The present invention advantageously allows for reduced initial higher RSE monomer concentrations that allow for living ROMP to proceed without depolymerization relative to the lower RSE monomer. Polymerization of the non-isomerized monomers according to the present invention required concentrations of 2.0 M or greater.

In embodiments of the present invention employing isomerized monomer, the initial monomer concentration is at least 0.010 M. In other embodiments, the initial monomer concentration is at least 0.015 M. In other embodiments, the initial monomer concentration is at least 0.020 M. In other embodiments, the initial monomer concentration is at least 0.025 M. In other embodiments, the initial monomer concentration is at least 0.030 M.

In embodiments of the present invention using ruthenium catalysts for living ROMP of the isomerized cycloalkene-fused ring monomer, the monomer/initiator ratio is at least 400/1. In other embodiments, the the monomer/initiator ratio is at least 350/1. the monomer/initiator ratio is at least 300/1. the monomer/initiator ratio is at least 250/1.

In some embodiments, a weakly coordinating ligand is used during living ROMP to provide control over the molecular weight distributions of the formed polymer. In embodiments of the present invention using a weakly coordinating ligand during living ROMP, the amount of weakly coordinating ligand is at least 10 equivalents or greater than the amount of catalyst. In other embodiments, the amount of weakly coordinating ligand is at least 15 equivalents or greater than the amount of catalyst. In other embodiments, the amount of weakly coordinating ligand is at least 20 equivalents or greater than the amount of catalyst. In other embodiments the amount of weakly coordinating ligand is at least 25 equivalents or greater than the amount of catalyst.

Weakly coordinating ligands (also known as weak field ligands) present during living ROMP suppress secondary metathesis. Weakly coordinating ligands from complexes with the catalyst. A suitable weakly coordinating ligand suitable for use with monomers according to the present invention is triphenylphosphine (PPh₃). Other weakly coordinating ligands known in the art are acceptable to suppress secondary metathesis.

Coordinating solvents used during living ROMP were observed to control polymerization of the monomers according to the present invention. Further, mixed solvents are acceptable allowing for dissolving of certain monomers or polymers that may not dissolve in one type of coordinating solvent, thereby improving polymerization. Two suitable coordinating solvents include at least tetrahydroguran (THF), dichloromethane (DCM). Other suitable coordinating solvents known in the art ar acceptable to control polymerization of monomers according to the present invention.

The present invention further relates to a method of controlling the molecular weight of a polymer by varying the monomer-to-initiator ratio during the polymerization process. In some embodiments, increasing the monomer-to-initiator ratio results in a polymer with an increased molecular weight. Through the use of this method, the properties of the resulting polymer can be tailored to meet specific requirements for a given application. The method has been demonstrated through the conduct of five polymerizations with varying monomer-to-initiator ratios, which resulted in a linear increase in molecular weight, up to an ultra-high degree of polymerization, corresponding to a high molecular weight. Additionally, the method has been shown to be effective in controlling the molecular weight of the polymer and avoiding the reduction in conversion that is commonly seen with other polymerization methods. This method is useful for applications that require large-size, well-defined graft polymers.

In some embodiments, the present invention provides for the formation of copolymers through sequential addition of two or more monomers. This allows for the formation of block copolymers with specific properties such as the ability to undergo microphase separation to form nanostructures, such as lamellae. Additionally, the method allows for the formation of specific microphase separation patterns by using unique graft architecture which advantageously provides tailoring-opportunities for various applications.

In some embodiments graft polymers according to the present invention undergo depolymerization through an end-to-end unzipping mechanism. In these and other embodiments, depolymerization yields a plurality of macromonomer units. In some embodiments depolymerization occurs in the presence of a Grubb’s catalyst. In some embodiments the Grubb’s catalyst is a second-generation Grubb’s catalyst. In some embodiments, the depolymerization may occur at temperatures of 100° C. or less. In other embodiments, 90° C. or less. In other embodiments, 80° C. or less. In other embodiments, 70° C. or less. In other embodiments, 60° C. or less. In other embodiments, 50° C. or less. In some embodiments depolymerization of graft polymers according to the present invention, the resulting macromonomer units are in low-ring strain configurations. Without wishing to be bound by theory, it is found that the selective formation of the low-strain isomer during depolymerization is consistent with the behavior of fused ring monomers without polymer sidechains.

The depolymerizability of the present graft polymer system provides for sustainable thermoplastics based on the graft architecture, which, compared to linear polymers, can possess more diverse properties. In some embodiments, statistical graft copolymers according to the present invention form thermoplastic materials. In these and other embodiments, thermoplastic materials may be chemically recycled into monomer and polymeric sidechains.

In light of the foregoing, it should be appreciated that the present invention significantly advances the art by providing graft (co)polymers that are structurally and functionally improved in a number of ways. While particular embodiments of the invention have been disclosed in detail herein, it should be appreciated that the invention is not limited thereto or thereby inasmuch as variations on the invention herein will be readily appreciated by those of ordinary skill in the art. The scope of the invention shall be appreciated from the claims that follow.

### EXAMPLES

In order to demonstrate the practice of the present invention, the following examples have been prepared and tested. The examples should not, however, be viewed as limiting the scope of the invention. The claims will serve to define the invention.

Graft polymers according to the present invention were investigated using the following materials. Specific materials used include: poly(ethylene glycol) methyl ether (mPEG) was dried by azeotropic distillation in toluene before use; L-Lactide was recrystallized from ethyl acetate three times and stored in a cold, inert atmosphere; Triphenyl phosphine (PPh₃) was recrystallized from toluene prior to use; All other reagents and solvents purchased from commercial suppliers were used without further purification unless noted otherwise. The following were synthesized according to known methods in the art: 2-hydroxyethyl tert-butyldimethylsilyl ether and mPEG—CO₂H (2 kDa). Any non-solid tCBtCO products was kept in a dilute solution with a known amount of BHT to prevent radical-induced side reactions on trans-cyclooctene and as an internal reference for mass calculation. Silicycle F60 (230-400 mesh) silica gel was used to perform column, also known as flash, chromatography. LaboACE LC-5060 recycling preparative HPLC system equipped with two JAIGEL-2HR GPC columns performing in HPLC-grade chloroform (0.75% ethanol preserved) was used for polymer purification where indicated. Spectra/Por® 4 Dialysis Tubing (12-14 kDa MWCO) was purchased from Repligen and rinsed in DI H₂O prior to use.

### Example 1

### A. Synthesis of Macromonomer Precursors

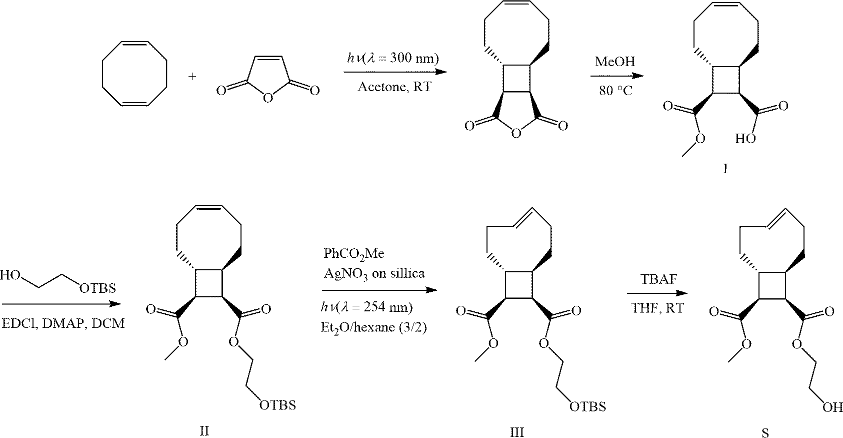

### I. Trans-Cyclobutane Fused Cis-cyclooctene Ester Acid

The ester acid I synthesis was performed according to the following method. To a quartz flask equipped with a stir bar, a solution of maleic anhydride (8.8 g, 89.8 mmol, 1 equiv) and cyclooctadiene (19.4 g, 179.6 mmol, 2 equiv) in acetone (500 mL) was added. The solution was sparged with nitrogen for 30 minutes followed by irradiation with 16 UV lamps (λ =300 nm) in a Rayonet photoreactor chamber for 16 h. The mixture was then concentrated on a rotary evaporator and precipitated in diethyl ether three times to remove the polymeric byproducts. The collected supernatant was concentrated, suspended in MeOH (500 mL), and brought to reflux under vigorous stirring for >4 hours until a clear solution was obtained. The resulting crude product was purified by flash column chromatography (acetone/hexane, ⅓ v/v), followed by recrystallization from an EtOAc/hexane mixture to yield a colorless crystalline product (5.3 g, 25%). Spectral data confirmed synthesis of ester acid I.

### II. Trans-Cyclobutane Fused Cis-cyclooctene Silyl Ether

The synthesis of II was performed according to the following method. To a 250 mL round-bottom flask with a stir bar, I (3727.6 mg, 15.6 mmol, 1 equiv), 4-dimethylaminopyridine (DMAP, 191.1 mg, 1.56 mmol, 0.1 equiv), 2-hydroxyethyl tert-butyldimethylsilyl ether (3030.7 mg, 17.2 mmol, 1.1 equiv), N-(3-dimethylaminopropyl)-N′-ethylcarbodiimide hydrochloride (EDCl, 6000 mg, 30.3 mmol, 2 equiv), and DCM (80 mL) were added. The mixture was stirred for 18 hours at room temperature. The product mixture was diluted with DCM and washed with water (2 × 200 mL). The organic layer was dried over Na₂SO₄, filtered, and concentrated on a rotary evaporator. The yellow crude oil (6.9 g) was purified via flash column chromatography (EtOAc/hexane, 8/92 v/v) yielding a slightly yellow oil II (3850 mg, 62%).

### III. Trans-Cyclobutane Fused Trans-cyclooctene Silyl Ether

The synthesis of III was performed according to the following method. Using a flow photochemistry setup, II (3.85 g, 9.71 mmol, 1 equiv) and methyl benzoate (1.32 g, 9.71 mmol, 1 equiv) were dissolved in 150 mL of Et₂O/hexane (3/2 v/v) in a quartz tube. A column was filled with 10 wt.% AgNO₃-impregnated silica gel (33 g, 19.4 mmol of AgNO₃, 2 equiv) and the remaining space (downstream side) was filled with regular silica gel to prevent AgNO₃ leaching, with both ends plugged with cotton balls. The reaction mixture was irradiated for 17 hours in a Rayonet photoreactor chamber with 16 RPR2537A lamps (λ =254 nm), while being circulated through the abovementioned column using a metering pump. The column was dried by air stream and emptied into a separate column which was pre-packed by a layer of regular silica gel (33 g) at the bottom and a fresh AgNO₃-impregnated silica gel layer (33 g, 19.4 mmol of AgNO₃, 2 equiv). The remaining reaction mixture was eluted through the work-up column by 750 mL of Et₂O/hexane (3/2 v/v). The collected solution was concentrated and purified via flash column chromatography (EtOAc/hexane 8/92 v/v) to recover the unreacted cis-isomer reactant (1.11 g, 29%). The column was further purged with 750 mL of acetone. The eluted solution was dried and 30% NH₄OH aqueous solution was added. The solution was extracted with DCM (5 × 300 mL), dried over Na₂SO₄, filtered, and concentrated on a rotary evaporator. The brown crude oil was purified via flash column chromatography (EtOAc/hexane, 8/92 v/v) to yield an oil III (2.25 g, 58%).

### S. Trans-Cyclobutane Fused Trans-cyclooctene Alcohol

The synthesis of S was performed according to the following method. The desilylation of the photoisomerization product was carried out in the presence of a fluoride source instead of a strong Brønsted acid (e.g. HCl), as the Brønsted acid could be detrimental to trans-cyclooctenes. Acetic acid was initially used to buffer the nucleophilicity of the alkoxide intermediate out of concern of transesterification, but it was found that using only tetrabutylammonium fluoride (TBAF) was acceptable. Specifically, TBAF (1 M solution in THF, 11.2 mL, 2 equiv) was added to a solution of III (2250 mg, 5.67 mmol, 1 equiv) in THF (5.67 mL). The mixture was stirred at ambient conditions for 30 minutes, which allowed for full consumption of III. The reaction mixture was then diluted with EtOAc, washed with DI H₂O three times and brine, and filtered through Na₂SO₄ over a cotton ball. The solution was concentrated and directly loaded on a silica column and eluted with EtOAc/hexane (1/1 v/v) to yield a slightly yellow oil S (1282 mg, 80%).

### B. Synthesis of Macromonomers and Attachment of Polymeric Sidechains

### 1. Trans-Cyclobutane Fused Trans-Cyclooctene Poly(ethylene Glycol) (tCBtCO-PEG)

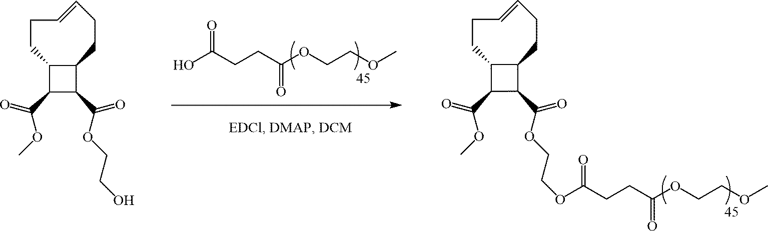

The synthesis of trans-Cyclobutane fused trans-cyclooctene poly(ethylene glycol) (tCBtCO-PEG) was performed according to the following method. To a 25 mL round-bottom flask with a stir bar, S (100 mg, 0.35 mmol, 1.2 equiv), DMAP (3.7 mg, 0.035 mmol, 0.1 equiv), PEG-CO₂H (618 mg, 0.3 mmol, 1 equiv), EDCI (115 mg, 0.6 mmol, 2 equiv), and DCM (10 mL) were added. The mixture was stirred overnight under nitrogen. Subsequently, the reaction mixture was concentrated at reduced pressure and dissolved in 150 mL of water. The aqueous solution was washed with EtOAc/hexane (1/1 v/v, 3 × 200 mL) and extracted with DCM (6 × 200 mL). The DCM layer was dried over Na₂SO₄, filtered, concentrated at reduced pressure, and precipitated into cold Et20 two times. The precipitate was collected as a white solid product 1 (475 mg, yield: 67%). ¹H NMR spectrum suggested 98% end-group functionality according to the following: ¹H NMR (500 MHz, CDCl₃, ppm): δ 5.88-5.43 (m, 2H), 4.34-4.19 (m, 6H), 3.71-3.58 (m, 178H), 3.39 (t, 1H), 3.38 (s, 3H), 2.73-2.58 (m, 5H), 2.53 (q, 1H), 2.42-2.17 (m, 3H), 2.16-2.09 (m, 1H), 2.09-1.87 (m, 2H), 1.84-1.76 (m, 1H), 1.65-1.57 (m, 1H), 1.57-1.46 (m, 1H).

### 2. Trans-Cyclobutane Fused Trans-Cyclooctene Poly(L-lactide) (tCBtCO-PLLA)

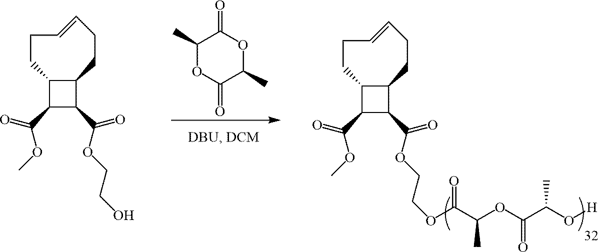

The synthesis of trans-Cyclobutane fused trans-cyclooctene poly(ethylene glycol) (tCBtCO-PEG) was performed according to the following method. In a nitrogen-filled MBraun Unilab glovebox, stock solutions of S (280 mg, 0.991 mmol, 1 equiv), L-lactide (5000 mg, 34.7 mmol, 35 equiv), and 1,8-diazabicyclo[5.4.0]undec-7-ene (DBU, 15.09 mg, 0.0991 mmol, 0.1 equiv) in DCM were prepared separately to reach a total volume of 34.7 mL, and stored over molecular sieves one day prior to the polymerization. The alcohol initiator, DBU, and L-lactide stock solutions under vigorous stirring were sequentially added to a flame-dried Schlenk flask under vigorous stirring. After 10 minutes, 0.12 mL acetic acid was added to quench the polymerization. The mixture was dried under reduced pressure and redissolved in 10 mL THF and 10 mL DCM (to ensure full dissolution and miscibility with methanol/water mixture), followed by precipitation into excess methanol/water (1/1 v/v) and diethyl ether to collect a white solid 2, which was ground into fine powder using a spatula and dried in a vacuum oven (3.8 g, 72%). The following ¹H NMR (500 MHz, CDCl₃, ppm) data was obtained: δ 5.89-5.43 (m, 2H), 5.27-5.05 (q. 64H), 4.43-4.14 (m, 5H), 6.63 (s, 3H), 3.37 (t, 1H), 2.80-2.58 (m, 2H), 2.52 (q, 1H), 2.43-2.11 (m, 4H), 2.06-1.96 (m, 2H), 1.89-1.82 (m, 1), 1.64-1.46 (d, 192H).

### 3. Trans-Cyclobutane Fused Trans-Cyclooctene Margarate (tCBtCO-C17)

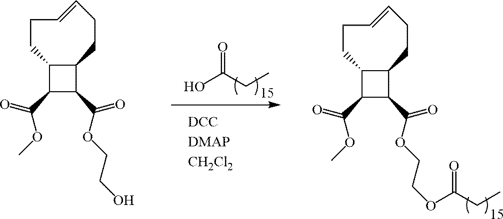

The synthesis of trans-Cyclobutane fused trans-cyclooctene margarate (tCBtCO-C17) was performed according to the following esterification method. In a 20 mL vial with a stir bar, S (296.1 mg, 1.05 mmol, 1 equiv), DMAP (12.8 mg, 0.105 mmol, 0.1 equiv), margaric acid (283.8 mg, 1.05 mmol, 1 equiv), DCC (546.7 mg, 2.10 mmol, 2 equiv),and DCM (5 mL) were added. The mixture was stirred for 18 hours at room temperature. Insoluble solids were filtered, and the solution was concentrated on a rotary evaporator. The slightly yellow crude oil was purified via flash column chromatography (Et₂O/hexane, 3/7 v/v) yielding a slightly yellow oil 3 (357.9 mg, 63.8%). The following ¹H NMR (500 MHz, CDCl₃, ppm) data was obtained: δ 5.94-5.33 (m, 2H), 4.37-4.16 (m, 4H), 3.64 (s, 3H), 3.39 (t, 1H), 2.63 (t, 1H), 2.58-2.49 (q, 1H), 2.32 (t, 2H), 2.27-2.09 (m, 4H), 2.08-1.95 (m, 2H), 1.83-1.77 (m, 1H), 1.68-1.57 (m, 3H), 1.54-1.47 (m, 1H), 1.36-1.16 (m, 26H), 0.88 (t, 3H).

### 3. Trans-Cyclobutane Fused Trans-Cyclooctene Margarate (tCBtCO-C17)

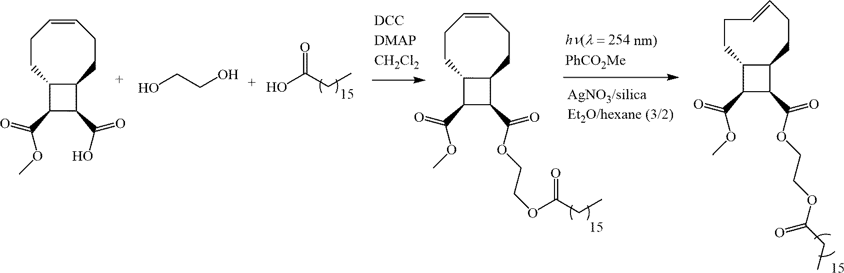

The synthesis of trans-Cyclobutane fused trans-cyclooctene margarate (tCBtCO-C17) was performed according to the following photoisomerization method. I (705.2 mg, 2.96 mmol, 1 equiv) and margaric acid (800.6 mg, 2.96 mmol, 1 equiv) were dissolved in DCM. Next, ethylene glycol (183.7 mg, 2.96 mmol, 1 equiv), N,N′-dicyclohexylcarbodiimide (DCC, 2441.8 mg, 11.8 mmol, 4 equiv) and DMAP (72.2 mg, 0.592 mmol, 0.2 equiv) were added. The mixture was left to stir overnight at room temperature in a nitrogen atmosphere. After, the mixture was filtered off from solids and concentrated on a rotary evaporator. The crude product was purified via flash column chromatography (Et₂O/hexane, 3/7 v/v) yielding a white solid Z3 (382 mg, 24%). The following ¹H NMR (500 MHz, CDCl₃, ppm) data was obtained: δ 5.57-5.47 (m, 2H), 4.36-4.18 (m, 4H), 3.65 (s, 3H), 3.40 (t, 1H), 2.88-2.75 (m, 1H), 2.70 (t, 1H), 2.48-2.35 (m, 1H), 2.32 (t, 2H), 2.29-2.20 (m, 1H), 2.20-2.10 (m, 2H), 2.10-1.98 (m, 2H), 1.67-1.55 (m, 3H), 1.38-1.12 (m, 28H), 0.88 (t, 3H).

The synthesis of 3 from Z3 (382 mg, 0.714 mmol) was similar to the synthesis of S, described above. The main difference included using an Et₂O/hexane (3/2 v/v) mixture as the circulating solvent. The crude product was purified by flash column chromatography (Et₂O/hexane, 3/7 v/v) to yield a slightly yellow oil 3 (75 mg, 20%). The following ¹H NMR (500 MHz, CDCl₃, ppm) data was obtained: δ 5.94-5.33 (m, 2H), 4.37-4.16 (m, 4H), 3.64 (s, 3H), 3.39 (t, 1H), 2.63 (t, 1H), 2.58-2.49 (q, 1H), 2.32 (t, 2H), 2.27-2.09 (m, 4H), 2.08-1.95 (m, 2H), 1.83-1.77 (m, 1H), 1.68-1.57 (m, 3H), 1.54-1.47 (m, 1H), 1.36-1.16 (m, 26H), 0.88 (t, 3H).

### C. Characteristics of Macromonomers

The properties of the above polymers, 1, 2, and 3 are included in Table 1.

TABLE 1

Characteristics of macromonomers

| MM | N^{[a]} | M_{n,NMR} (Da) ^{[a]} | M_{n,SEC} (Da)^{[b]} | Ð_{SEC}^{[b]} | dn/dc (mL/g) | M_{n,MALDI} (Da)^{[c]} | Ð_{MALDI}^{[c]} |
|---|---|---|---|---|---|---|---|
| 1 | 45 | 2357 | 6204 | 1.03 | 0.0566 | 2500 | 1.02 |
| 2 | 32 | 4890 | 4844 | 1.06 | 0.0452 | 4400 | 1.09 |
| 3 | N/A | 535 | N/A | N/A | N/A | N/A | N/A |

^{a}Determined by end-group analysis using ¹H NMR spectroscopy.
^{b}1 and 2 were measured by SEC-RI in DMF with 0.01 M LiBr against polystyrene standards and SEC-RI/MALS in THF, respectively.
^{c}Obtained from MALDI-ToF MS.

### Example 2

### A. Grafting-Through Polymerization of Macromonomers

All ring-opening metathesis polymerizations (ROMP) were carried out in a nitrogen-filled MBraun Unilab glovebox and occasionally removed from the glovebox after the setup. The general procedure included providing a macromonomer (MM) and PPh₃ (30 equiv) dissolved in degassed THF, before adding, by micropipette, a Grubbs 1^{st} generation catalyst (G1 equiv) stock solution in degassed THF to reach a macromonomer concentration of ≥0.025 M. The mixture was left to stir vigorously for at least 1 hour at room temperature and was quenched by adding ethyl vinyl ether (EVE). To monitor the kinetics, aliquots were taken at given time intervals, quenched with EVE and subjected to NMR and/or SEC analysis.

### P1. PtCBCO-g-PEG

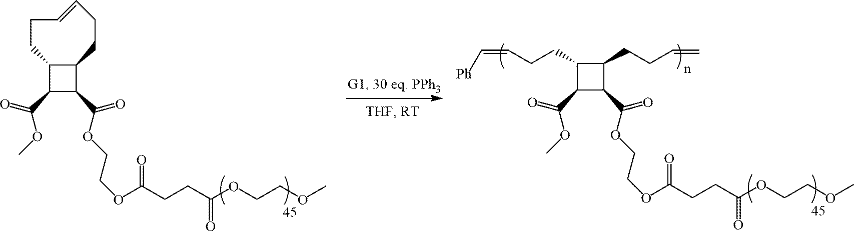

P1 was synthesized according to the above procedure and purified by precipitation into cold diethyl ether and dialysis against DI H₂O.

### P2. PtCBCO-g-PLLA

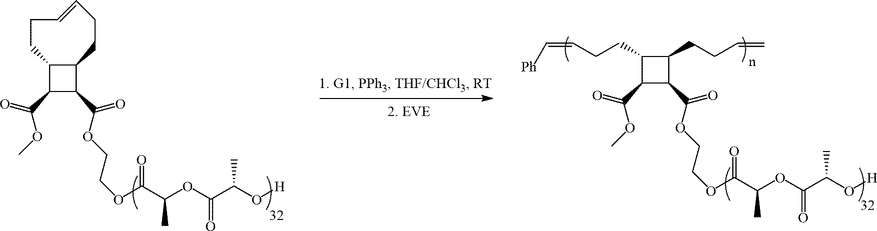

P2 was synthesized according to the above procedure, except that a THF/chloroform (¼ v/v) mixture was used as the solvent due to the limited solubility of 2 in pure THF and purified by precipitation into cold diethyl ether and dialysis against MeOH/DCM (1/1 v/v).

### P3. PtCBCO-g-C17

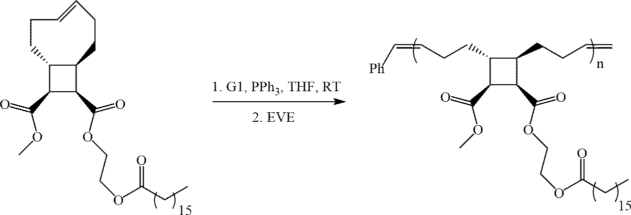

P3 was synthesized according to the above procedure and purified by preparative GPC.

### P3-b-P1. (PtCBCO-g-C17)-b-(PtCBCO-g-PEG)

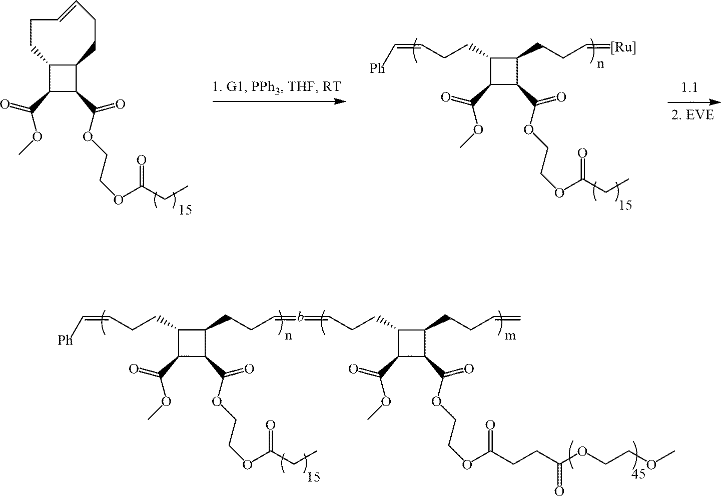

Copolymer synthesis was also demonstrated. The synthesis of P3-b-P1 was performed according to the following procedure. In a 4 mL vial, 3 (129.0 mg, 0.241 mmol, 100 equiv) and PPh₃ (19.0 mg, 0.0724 mmol, 30 equiv) were dissolved in THF (189.9 µL). A stock solution of G1 in THF (1% w/v) was prepared, and 189.9 mL of G1 (1.986 mg, 2.41 µmol, 1 equiv) was added to the stirring mixture of 3 via a micropipette. The mixture was stirred at room temperature for 10 minutes, before 10% of the reaction mixture (38.9 mL) as an aliquot was transferred to another vial containing EVE to be quenched and analyzed with SEC and NMR. A stock solution of 1 (51.6 mg, 0.0217 mmol, 9 equiv) was then added to the remaining reaction mixture, and the polymerization was allowed to proceed for another 30 minutes followed by the addition of EVE to quench the polymerization. The crude diblock copolymer was purified by preparative GPC followed by dialysis against MeOH.

### P2-stat-P3. (PtCBCO-g-C17)-stat-(PtCBCO-g-PLLA)

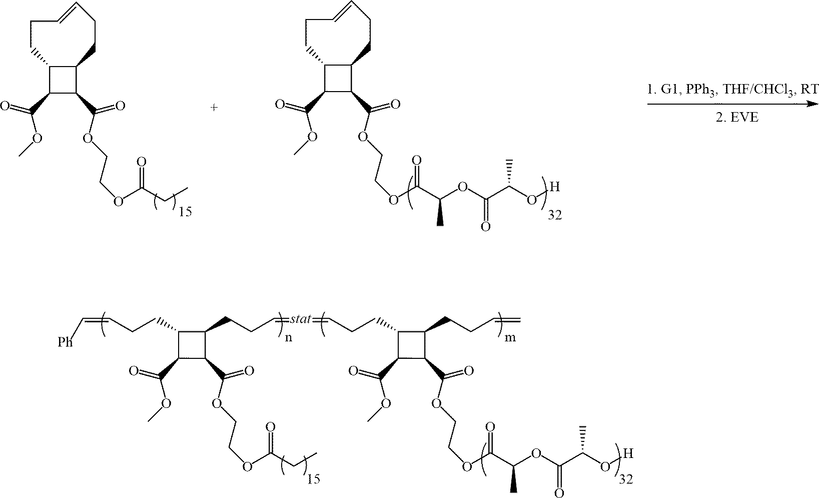

The synthesis of P2-stat-P3 was performed according to the following procedure. In a 20 mL scintillation vial, 2 (350.5 mg, 0.0716 mmol, 300 equiv) and 3 (344.7 mg, 0.644 mmol, 2700 equiv) were dissolved in a mixture of THF (1.2 mL) and CHCl₃ (5.7 mL) before 187.8 µL of PPh₃ (1.88 mg, 7.16 µmol, 30 equiv) stock solution in THF (1% w/v) was added. Upon complete dissolution, 196 µL of G1 (0.20 mg, 0.239 µmol, 1 equiv) stock solution in THF (0.1% w/v) was quickly added to the rapidly stirring mixture via a micropipette. The mixture was left to stir at room temperature for 3 hours before being quenched by 0.1 mL EVE. The polymer was isolated by precipitation into cold diethyl ether and filtration, which was then mixed with 1% BHT in minimal amount of DCM and dried in a PTFE beaker in a vacuum oven at 60° C. to yield a transparent film (460 mg, 66%).

### C. Characteristics of Graft (co)Polymers

The properties of the above polymers, 1, 2, 3, P3-b-P1, and P2-stat-P3 are included in Table 2. The table includes the ratio of macromonomer to initiator, degree of polymerization, average molecular weight, dispersity, and specific refractive index increment.

TABLE 2

Characteristics of graft (co)polymers

| Sample | [MMₓ]₀/[G1]₀: [MM_{y}]₀/[G1]₀ | DP^{[a]} | Mₙ (kDa)^{[a]} | Ð^{[a]} | dn/dc (mL/g) |
|---|---|---|---|---|---|
| P1 | 100 | 131 | 312 | 1.05 | 0.0566 |
| P2 | 100 | 109 | 526 | 1.01 | 0.0442 |
| P2 | 500 | 446 | 2161 | 1.08 | 0.0442 |
| P2 | 1000 | 1103 | 5341 | 1.02 | 0.0442 |
| P2 | 2000 | 2122 | 10280 | 1.09 | 0.0442 |
| P2 | 3000 | 2962 | 14350 | 1.17 | 0.0442 |
| P3 | 100 | 127 | 68 | 1.12 | 0.1068 |
| P3-b-P1 | 100:10 | 127:14^{b} | 221 | 1.15 | 0.0913 |
| P2-stat-P3 | 2700:300 | 3567:360^{c} | 3654 | 1.10 | 0.0538 |

^{a}Measured by SEC-RI/MALS in DMF with 0.01 M LiBr for entry 1 and in THF for others.
^{b}Determined by ¹H NMR by comparing the integrations of two different side chains.
^{c}Calculated from an equation system using ¹H NMR and SEC-RI/MALS results: DP₃/DP₂ = 9.9 and (DP₃×M₃)+(DP₂×M₂) = M_{n,P2-stat-P3}.

Table 3 includes the results of uniaxial tensile testing (ASTM D1708-18) was performed on an Instron 5543 universal testing machine with pneumatic grips with a gripping pressure set at 25 psi and a 100 N load cell at a cross-head velocity of 5 mm/min of P2-stat-P3 samples. Dumbbell specimens were prepared by using a hydraulic Carver Press by compression molding in a steel mold sandwiched between PTFE sheets under a 22 kN force at 170° C. for 3 min. Four replicates were tested. Young’s moduli were determined from the slope of the fitted line to the linear 1% deformation region.

TABLE 3

Tensile properties of ductile P2-stat-P3 samples.

| E (MPa) | ε_{y} (%) | σ_{y} (MPa) | ε_{b} (%) | σ_{b} (MPa) |
|---|---|---|---|---|
| 130 ± 18 | 12.9 ± 0.7 | 4.4 ± 0.4 | 222 ± 35 | 8.5 ± 0.3 |

### Example III

### A. Depolymerization of Graft (Co)Polymers

A general procedure for studying depolymerization of the above polymers is included below. A microwave vial was charged with graft polymer solution in toluene, capped with a septum, and purged with nitrogen for 30 min. Toluene and Grubbs 2^{nd} generation catalyst (G2) were added to two separate round bottom flasks, respectively, and were also purged with nitrogen for 30 min. Toluene was introduced via syringe to the G2 container to obtain a predetermined concentration. After complete dissolution, a desired amount of G2 stock solution was transferred into the polymer solution to provide an [olefin]₀ = 0.01 M with 1 mol%G2. The solution was allowed to stir at 50° C. under nitrogen. Aliquots were taken at given time intervals, quenched with EVE and subjected to SEC analysis to monitor the depolymerization process over time. Peaks from SEC-RI traces were integrated to obtain fractions of the remaining graft polymer, oligomeric MMs and MM.

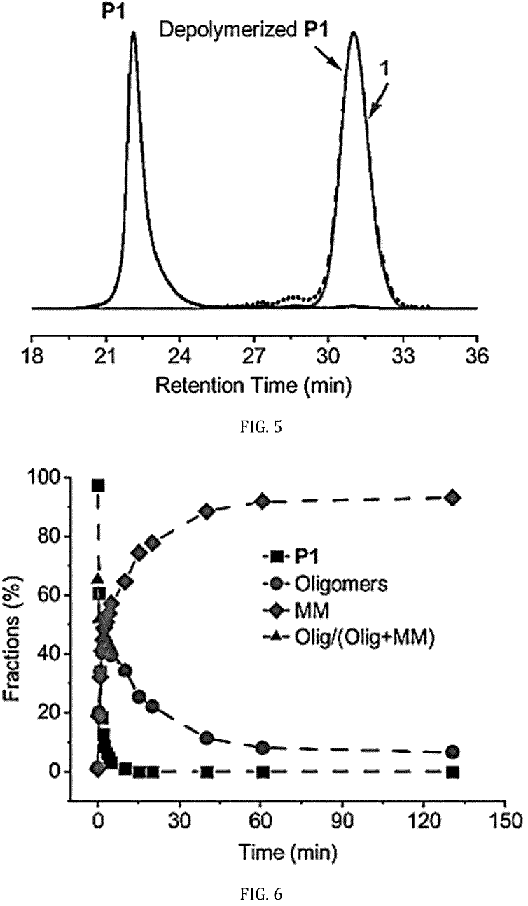

Depolymerization of graft polymers was tested using P1. A solution of P1 with [olefin]₀ = 0.01 M and 1 mol% G2 in toluene was degassed and then heated at 50° C. while stirring in a nitrogen atmosphere overnight. The resulting product was analyzed using ¹H NMR which showed that the obtained macromonomer was not tCBtCO macromonomer 1 and was instead the cis-cyclooctene form. Without wishing to be bound by theory, it is believed that this observation is due to the high ring strain energy of the trans-cyclooctene. SEC-RI traces revealed that P1 was completely consumed after depolymerization and macromonomer along with a small fraction of oligomers formed, as shown in FIG. 5.

To further understand the depolymerization process, the depolymerization kinetics of P1 using SEC of aliquots as noted above. As the depolymerization proceeded, the fraction of P1 decreased, and the SEC peak of P1 was observed to disappear after 15 minutes of depolymerization. The fraction of oligomers increased in the beginning and reached a maximum of ~40% before gradually decreasing. Most of the oligomers were converted into the monomer after 130 minutes of depolymerization, at which point, the fractions of oligomers and macromonomers were 7% and 93%, respectively. Notably, the molecular weight of the residual P1 (retention time 20-24.5 minutes) did not decrease significantly until the very late stage of depolymerization, when the solution contains primarily the tCBcCO macromonomer and oligomers. For example, the reduction in Mₙ is less than 30% even at 80% of depolymerization. The slow molecular weight reduction of the residual P1 rules out a random chain scission mechanism―which would lead to exponential decay in molecular weight. Instead, the results support an end-to-end unzipping mechanism. If all the chains underwent unzipping depolymerization simultaneously, the observed changes in Mₙ would show a linear decrease with the percentage of depolymerization. Instead, the observed slow molecular weight reduction, suggests that at any point in time only a very low fraction of chains underwent depolymerization. Without wishing to be bound by theory it is believed that this behavior is attributed to the slow coordination of the Ru catalyst to the chain end due to the steric hindrance in the densely grafted architecture.

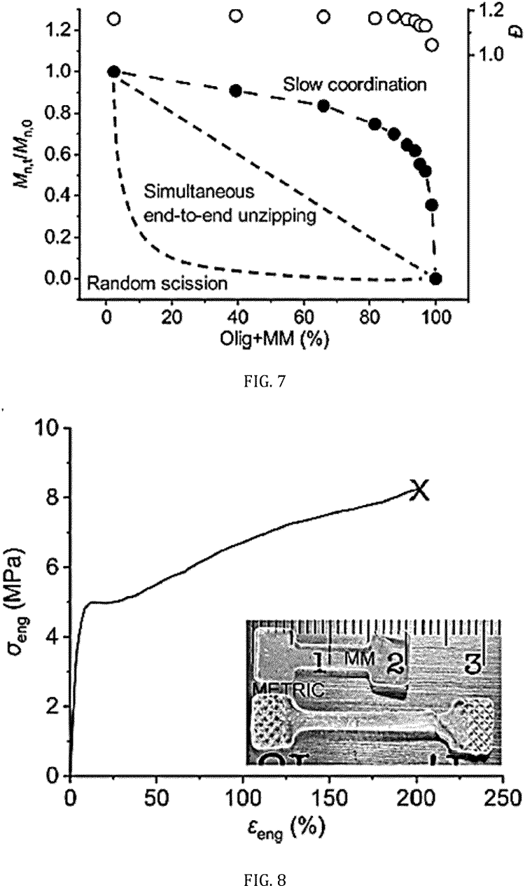

The results of the above depolymerization kinetics study are shown in FIGS. 6 and 7. FIG. 6 shows the fraction of remaining P1 (squares), oligomers (circles), macromonomer (diamonds), and oligomers/(oligomers+MM) (triangles) as a function of depolymerization time. FIG. 7 shows the normalized Mₙ of P1 (M_{n,t}: Mₙ of the remaining P1 during depolymerization, M_{n,o}: Mₙ of the initial P1) (solid circles) and Ð of the remaining P1 (hollow circles) as a function of depolymerization percentage.

### Depolymerization of Thermoplastic Based Upon P2-stat-P3

A thermoplastic material based upon the statistical copolymer of P2 and P3 was produced. The glassy/semicrystalline P2 acted as the physical crosslinking point and the molten P3 bridged the hard domains . A [2]o/[3]o/[G1]o ratio of 300/2700/1 was used for ROMP, and the polymerization was quenched by EVE at 3 hours, yielding a conversion of 96%. The resulting polymer showed a narrow molecular weight distribution, and with Mₙ close to the theoretical value (See Table 1). The resulting P2-stat-P3 was purified by precipitation in cold diethyl ether. NMR analysis revealed that the molar ratio of incorporated 2 and 3 is 1:9.9, close to the feed ratio, 9:1, corresponding to a mass ratio of 13:12. The copolymer was able to undergo facile depolymerization into a compostable short PLLA and a tCBcCO-based fatty acid molecule, the latter of which can be photochemically isomerized to its trans analog.

X-ray scattering was utilized to study the morphological features of the copolymer. The presence of a broad principal SAXS peak suggests microphase separation while the absence of higher-order peaks excludes well-ordered structure (e.g., lamellar morphology). The domain spacing (17 nm) is similar to what was observed for brush random copolymers with comparable graft length, supporting a random instead of tapered/gradient copolymer composition, which would result in a much larger domain spacing. Elevating the temperature to 180° C. significantly weakened and broadened the SAXS peak due to disordering. Cooling the sample to 38° C., yielded a narrower peak found at the same q value, suggesting that a stronger microphase separation was recovered.

Mechanical properties of the thermoplastic graft copolymer were evaluated by uniaxial extension testing on dog-bone specimens prepared through compression molding at 170° C. Average values of the tensile properties were obtained from four replicates: Young’s modulus (130 ± 18 MPa), yield stress (4.4 ± 0.4 MPa), and stress at break (8.5 ± 0.3 MPa). These values are comparable to those of low-density polyethylene: Young’s modulus (280 ± 40 MPa), yield stress (8 ± 1 MPa), and stress at break (10 ± 2 MPa MPa), suggesting the potential of using tCBtCO-based graft copolymers as sustainable thermoplastics. FIG. 8 shows a representative stress-strain curve of a dumbbell specimen (also shown) extended at a cross-head speed of 5 mm/min. The specimen underwent an initially linear elastic deformation, followed by yielding, and further elongation until failure at three times its original length. The ruptured specimen remained about twice its original length, suggesting comparable portions of elastic and plastic deformation.

The conflicting thermodynamic demand between grafting-through and depolymerization is addressed by using tCBtCO-based macromonomers, in which the trans-cyclooctene enables highly endergonic living polymerization for grafting-through while the trans-cyclobutane fused ring makes depolymerization favorable by reducing the ring strain energy of the cyclooctene. The grafting-through of the tCBtCO-based macromonomers represents a rare case where depolymerizable graft polymers can be accessed while the size, functionality, and architecture of the graft polymers can be precisely controlled. These capabilities along with the demonstrated mechanical testing make the tCBtCO graft copolymers promising candidates for developing recyclable plastic materials with diverse properties.

Various modifications and alterations that do not depart from the scope and spirit of this invention will become apparent to those skilled in the art. This invention is not to be duly limited to the illustrative embodiments set forth herein.

What is claimed is:

1. A macromonomer capable of forming a graft polymer through graft-through polymerization, the graft polymer being capable of depolymerization, the macromonomer comprising:
a plurality of monomer units, the monomer units comprising a cycloalkene having a fused ring attached thereto to form a cycloalkene-fused ring monomer, wherein the fused ring decreases the ring strain energy of the cycloalkene to a lower ring strain energy state of 5.3 kcal/mol or lower as compared to the same cycloalkene without the fused ring having a ring strain energy above 5.3 kcal/mol, and wherein the cycloalkene of the cycloalkene-fused ring monomer is capable of isomerization into a higher ring strain energy state before graft-through polymerization, and at least one polymer sidechain bonded to the fused ring.

2. The macromonomer of claim 1, wherein the at least one polymer sidechain bonded to the fused ring comprises one or more of a poly(ethylene glycol), a polylactide, an aliphatic chain, a polycaprolactone, a polystyrene, and a polyacrylate.

3. The macromonomer of claim 1, wherein the cycloalkene is a 7- to 12-membered cycloalkene.

4. The macromonomer of claim 1, wherein the cycloalkene is an 8-membered cycloalkene, cyclooctene.

5. The macromonomer of claim 1, wherein the fused ring comprises trans-cyclobutane or trans-cyclopentane.

6. The macromonomer of claim 1, wherein the at least one polymer sidechain bonded to the fused ring is bonded after formation of the cycloalkene-fused ring monomer.

7. A graft polymer comprising:
a macromonomer backbone comprising a plurality of monomer units;
a plurality of polymer sidechains, where each polymer sidechain is bonded to one of the monomer units;
wherein each monomer unit of the plurality of monomer unites comprises a cycloalkene having a fused ring attached thereto to form a cycloalkene-fused ring monomer, wherein the fused ring decreases the ring strain energy of the cycloalkene to a lower ring strain energy state of 5.3 kcal/mol or lower as compared to the same cycloalkene without the fused ring having a ring strain energy above 5.3 kcal/mol, and wherein the cycloalkene of the cycloalkene-fused ring monomer is capable of isomerization into a higher ring strain energy state before graft-through polymerization,
wherein the macromonomer backbone is synthesized by ring-opening metathesis polymerization of the plurality of monomer units.

8. The graft polymer of claim 7, wherein the graft polymer is a bottlebrush polymer.

9. The graft polymer of claim 7, wherein a degree of polymerization is 1 or greater to 3,000.

10. The graft polymer of claim 7, wherein a degree of polymerization is ultrahigh.

11. The graft polymer of claim 7, wherein a degree of polymerization is 3,000.

12. The graft polymer of claim 7, wherein a number average molecular weight is 5,000 kDa or greater.

13. The graft polymer of claim 7, wherein upon a depolymerization returns to a lower ring strain energy for each monomer unit.

14. The graft polymer of claim 7, wherein the plurality of polymer sidechains comprises one or more of a poly(ethylene glycol), a polylactide, an aliphatic chain, a polycaprolactone, a polystyrene, and a polyacrylate.

15. The graft polymer of claim 7, comprising a copolymer including a second polymer covalently linked to the graft polymer.

16. The graft polymer of claim 15, wherein the second polymer comprises a different monomer backbone.

17. The graft polymer of claim 15, wherein the graft polymer is a statistical copolymer.

18. The graft polymer of claim 15, wherein the graft polymer is a block copolymer.

19. A method of synthesizing a graft polymer, the method comprising:
providing a plurality of monomer units, the monomer units comprising a cycloalkene having a fused ring attached thereto to form a cycloalkene-fused ring monomer, wherein the fused ring decreases the ring strain energy of the cycloalkene to a lower ring strain energy state of 5.3 kcal/mol or lower as compared to the same cycloalkene without the fused ring having a ring strain energy above 5.3 kcal/mol, and wherein the cycloalkene of the cycloalkene-fused ring monomer is capable of isomerization into a higher ring strain energy state, and wherein a polymer sidechain is bonded to each fused ring of the monomer units;
isomerizing the plurality of monomer units into the higher ring strain energy state;
performing ring-opening metathesis polymerization on the plurality of monomer units to obtain the graft polymer.

20. The method of claim 19, further comprising:
depolymerizing the graft polymer to obtain a plurality of monomer units wherein the cycloalkene of each monomer unit is in a lower ring strain energy state.
